(19) United States
(12) Patent Application Publication
(10) Pub. No.: US 2004/0056063 A1
(43) Pub. Date: Mar. 25, 2004

(54) Hand-guided working tool, in particular a fuel-driven setting tool

(76) Inventors: Ulrich Rosenbaum, Wangs (CH); Ulrich Schiestl, Feldkirch (AT); Hans Gschwend, Buchs (CH); Iwan Wolf, Chur (CH); Nikolaus Hannoschock, Zurich (CH); Peter Hertlein, Feldkrich (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/671,073

(22) Filed: Sep. 24, 2003

(30) Foreign Application Priority Data
Sep. 25, 2002 (DE) 102 44 508.7

(51) Int. Cl. B25C 1/14

(52) U.S. Cl. 227/10; 227/130

(57) ABSTRACT

A hand-guided working tool such as a fuel-driven setting tool (10) for driving fastening elements such as nails, bolts, pins and the like into a substrate. The setting tool (10) has a voltage source for supplying an electrical circuit onto the working tool (10) promising electrical consumers (12, 13, 21, 50). The voltage source is formed by at least one capacitor (31) arranged on the working tool, which is connected on the discharge side with the electrical circuit comprising the electrical consumers (12, 13, 21, 50) to make quick charging of the voltage source on the working tool (10) possible.

### BACKGROUND OF THE INVENTION

The present application relates to a hand-guided working tool, in particular a fuel-driven setting tool. Hand-guided working tools, such as fuel-driven setting tools, screw driving tools, electrical nail driving tools, for example, require electrical power as the main or ancillary energy for electrical consumers, control circuits, etc.

Fuel-driven setting tools that comprise a housing and a setting mechanism disposed therein, by which a fastener can be driven at a setting point in a substrate, when an operator triggers a setting operation using at least one switch, generally also comprise at least electronic components such as electronically controlled valves, ignition units, blowers, etc. These components and their control systems must be supplied with current, whereby mains independence is desirable. This energy is often provided by storage cells or batteries.

U.S. Pat. No. 4,403,722 discloses a gas-driven setting tool in which the mixture comprised of air and fuel gas situated in the combustion chamber prior to ignition is homogenized by an electrically driven blower. An NiCd storage battery is provided as the power supply for the blower drive and its control system.

A significant drawback of this type of power supply is the technology-related protracted charging time of the NiCd storage battery or alternatively storage batteries used. The charging process requires several hours even in a quick charge process. During this time, the working tool cannot be used unless the user carries a palette of exchange storage batteries.

### SUMMARY OF THE INVENTION

The object of the present invention is the development of a hand-guided working tool of the that can be operated independent of a fixed location and that makes quick uptake and storage of electrical energy possible.

This object is achieved according to the invention by at least one high-performance capacitor being provided on a hand-guided working tool such as a fuel-driven setting tool, for example, for supplying the tool with power. By virtue of the connection of the capacitor to a charging port on the hand-guided working tool, the capacitor can be connected to an external power source and then charged in a few minutes. The tool-internal circuits or electrical consumers, which draw the required electrical energy via a controller circuit, if required, are connected to the capacitor on the discharge side

advantageously, the capacitor(s) has a capacity of 10 F to 10,000 F. In an electrical consumption of 10 Ws/setting, for example, and a setting rate of 500 sets per day, a capacitor of 1,200 F, for example, can be used, which, depending on losses and incomplete dischargeability, must be charged only 5 to 10 times per day for a very short time (˜1 minute).

By virtue of the fact that the capacitors are removably arranged in a receptacle on the setting tool they can also be easily exchanged, depending on the battery type, and replaced by new, charged capacitors without the working tool or the setting tool having to be connected to an external power source.

It is also advantageous, if the capacitors are part of an energy storage module in which a plurality of capacitors are interconnected and can be contacted there via an common external connections. When exchanging capacitors, only the energy storage module need be replaced and not a plurality of capacitors, which makes replacement simpler.

### SUMMARY OF THE INVENTION

Further advantages and methods of the invention become apparent from the following description with reference to the drawings, wherein:

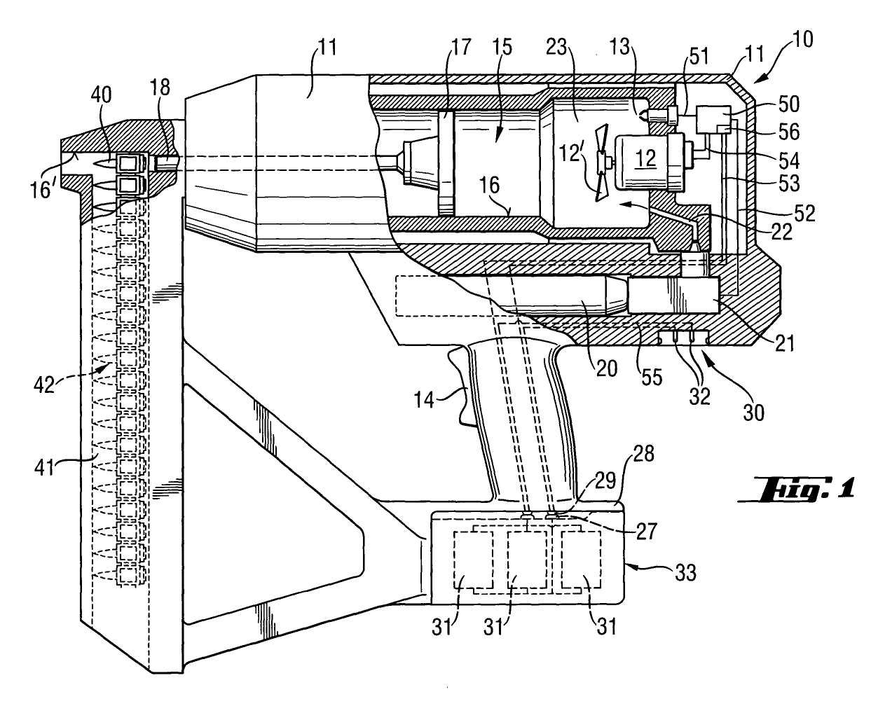

FIG. 1 shows a hand-guided setting tool in side view and partial cut-away, in accordance with the invention; and

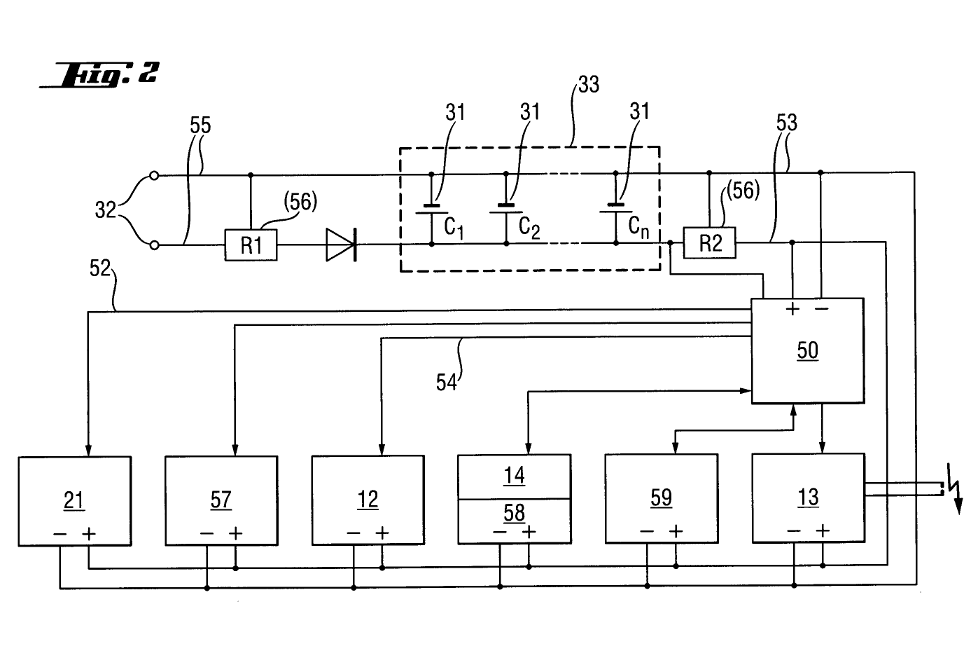

FIG. 2 shows a wiring layout of the control circuit of the setting tool of FIG. 1.

### DETAILED DESCRIPTION OF THE INVENTION

In FIG. 1 and FIG. 2, the hand-guided working tool 10 according to the invention is shown as a setting tool, which is driven using a combustible gas. The setting tool has a housing 1, in which a setting mechanism 15 is arranged, by a fastener element 40 to be driven into a substrate (not shown herein). The fastener element 40 moves over the setting side end 18 of the driving piston and is driven into a substrate when the working tool 10 or setting tool is pressed against the substrate.

The setting mechanism 15 comprises a firing chamber or combustion chamber 23, a piston guide 16, in which a striking piston 17 is displaceably mounted, and a bolt guide 16′ in which a fastener element 40 is guided. The fastening element 40 moves via the setting end 18 of the striking piston 17 forward and can be driven into a substrate.

In the exemplary embodiment a firing chamber 23, a blower 12 with a rotor 12′ or propeller and an ignition system 12, such as a spark plug, are arranged in the combustion or firing chamber 23. A turbulence is created in the burner or firing chamber using the blower 12 for mixing the fuel gas with air before an ignition spark is triggered by a control system 50 at the ignition unit 13 for igniting the fuel gas—air mixture.

The supply of the fuel gas in the combustion or firing chamber 23 occurs via a fuel feed line 22 and an electronically or mechanically controllable valve 21 from a fuel reservoir 20. The setting operation is triggered only after operating a trigger or trigger switch 14 on the hand grip of the setting tool 10. The switch can operate mechanically, electronically or even electromechanically.

In addition, further electrical or electromechanical switches can be provided on the setting tool that must be switched together or in different combinations to trigger a setting operation. These switches are a toggle-like, stacked switch or sensors that determine the nature of the substrate.

The power supply for the electrical consumers on the setting tool 10 such as the controller 50, the blower 12, the ignition unit 13, the trigger switch 14 and, if applicable, the other switches, the valve(s) 21 and other electronic components is provided in the present setting tool 10 using a capacitor 31. The capacitor 31 or the energy storage module 33 is arranged in a receptacle 28 on the setting tool 10 in the present exemplary embodiment and is arranged to be removable therefrom. The connection to the electrical electrical circuit in the setting tool 10 is made via contacts 27 on the energy storage module 33/capacitor 31, which co-operated with counter-contacts 29 in the receptacle 28.

The distribution of the electrical energy from the capacitor 31 to the electrical consumers and the transmission of electrical control impulses is done via the controller unit 50, which is arranged in a controller circuit 56 and over electrical input and control lines 51, 52, 53, 54. Charging of the capacitor 31 is done using a charging port 30, into which an electrical contact plug (not diagrammatically represented here) can be inserted. When this is done the plug contacts the electrical contacts 32 so that a charge current can flow over the electrical line 55 to the capacitor.

The fastening elements 40 are packaged in a magazine 41 in a magazine strip 42 that is disposed anterior on the setting tool 10. The fastening elements 40 can, however, be inserted individually into the bolt guide 16′ by the user without such a magazine 41 being required.

FIG. 2 shows a circuit layout for the setting tool of FIG. 1. In this instance, one or several capacitors 31 (C₁-Cₙ), which can be wired in series or in parallel, form the actual energy storage module 33. The controllers R1 and/or R2 (56) can be integrated in this energy storage module 33. R1 controls the charging process of the capacitors 31 and provides overload protection. R2 monitors the voltage of the capacitors 31 and controls them in a range, in which the control unit 50 and all connected electrical consumers, such as the dosing unit 21, the display 57, the actuators like the blower 12, the switches 14, the sensors 58, the safety module 59 and the ignition unit 13 function safely and reliably. R2 interrupts the current flow for the electrical consumers 21, 57, 12, 14, 58, 59, 13 in the event it falls below a defined minimal voltage. By picking up the capacitor voltage up stream of the controller R2 it is possible to determine the charge status of the capacitors, which can be displayed, for example, on a screen 57. As to the other legends, reference is made to the description of FIG. 1.

In summary, it must be noted that the invention is not limited to the embodiment represented. Hence, for example, a plurality of capacitors can be present. Similarly, the capacitor(s) can be arranged exchangeably in a special receptacle in the housing of the hand-guided working tool or setting tool.

What is claimed is:

1. A hand-guided working tool for driving fastening elements including one of nails, bolts, and pins into a substrate, having a voltage source for supplying an electrical circuit including electrical consumers (12, 13, 14, 21, 50, 57, 58, 59) on the working tool (10), wherein
the voltage source is formed by at least one capacitor (31) arranged on the working tool (10), the capacitor (31) being connected on the discharge side to the electrical circuit comprising the electrical consumers (12, 13, 14, 21, 50, 57, 58, 59).

2. The hand-guided working tool according to claim 1, wherein each of the at least one capacitors (31) on the charging side are equipped with a connection port (30) for an external power source for charging each of the at least one capacitors (31).

3. The hand-guided working tool of claim 1, wherein each of the at least one capacitors (31) are removably arranged in a receptacle (28) of the setting tool (10) and are connected to the electrical circuit comprising the electrical consumers (12, 13, 14, 21, 50, 57, 58, 59) via contacts (27) and counter-contacts (29).

4. The hand-guided working tool of claim 3, wherein each of the at least one capacitors (31) have a capacitance in the range of from 5 F to 10,000 F.

5. The hand-guided working tool of claim 4, wherein each of the at least one capacitors (31) are interconnected to form an energy storage module (33).

6. The hand-guided working tool of claim 5, wherein a control circuit (56) is connected downstream of each of the at least one capacitors (31) on the discharge side, wherein the electrical energy supplied by each of the at least one capacitors (31) to the electrical circuit with the electrical consumers (12, 13, 21, 50) is regulated.

7. The hand-guided working tool of claim 6, wherein the control circuit (56) is formed by at least one of a controller R1 and two controllers R1 and R2.
